(19) United States
(12) Patent Application Publication
(10) Pub. No.: US 2005/0122537 A1
(43) Pub. Date: Jun. 9, 2005

(54) Combination machine having an image data conversion function and image data conversion method therefor

(76) Inventors: Dong-hyup Shin, Seongnam-si (KR); Sea-chul Bae, Suwon-si (KR)

Correspondence Address: STANZIONE & KIM, LLP, 1740 N STREET, N.W., FIRST FLOOR, WASHINGTON, DC, 20036, US

(21) Appl. No.: 10/997,971

(22) Filed: Nov. 29, 2004

(30) Foreign Application Priority Data
Dec. 5, 2003 (KR) 2003-88193
Dec. 5, 2003 (KR) 2003-88196
Jan. 20, 2004 (KR) 2004-4271

(51) Int. Cl. G06K 15/02; H04N 1/00; G06K 9/00; G06F 17/20; G06F 17/28; G10L 13/08; G10L 13/00

(52) U.S. Cl. 358/1.13; 704/2; 704/8; 704/260; 382/176; 382/181; 358/400

(57) ABSTRACT

A combination machine having an image data conversion function. The combination machine has at least two modules among a scanner module to project light onto documents and produce images, a photocopier module to output the images onto paper, and a facsimile machine module to send images through a communication channel and to receive images through the communication channel, including a character recognition part to recognize characters on the images, a translation part to translate the recognized characters into a different language, and a controller to control the character recognition part and the translation part to translate the images into the different language and to convert the characters translated in the different language into images. Accordingly, the combination machine can translate images with respect to text on documents, convert the images into a voice, and convert into an image format processable by an external display device on a user's single command.

### CROSS-REFERENCE TO RELATED APPLICATIONS

This application claims benefit under 35 U.S.C. § 119 from Korean Patent Application Nos. 2003-88193 filed on Dec. 5, 2003, 2003-88196 filed on Dec. 5, 2003, and 2004-4271 filed on Jan. 20, 2004 with the Korean Intellectual Property Office, the entire content of which is incorporated herein by reference.

### BACKGROUND OF THE INVENTION

1. Field of the Invention

The present general inventive concept generally relates to a combination machine having an image data conversion function and an image data conversion method therefor. More particularly, the present general inventive concept relates to a combination machine having an image data conversion function and an image data conversion method therefor capable of converting documents printed on paper into different languages, outputting or faxing the language-converted documents, and converting the printed documents into an image format displayable on an external display device or into a voice signal, wherein the combination machine refers to a machine into which a scanner, a photocopier, and a printer are incorporated.

2. Description of the Related Art

With developments and more demands of office automation devices recently, the combination machines such as multi-function copiers (MFCs) having multiple functions to allow a user to do various tasks have been proposed. The recent combination machines on the market are each structured with a facsimile machine, a photocopier, and/or a scanner that are incorporated therein, and provided with scanner/printer engines and host PC interfaces, so as to perform diverse tasks.

Furthermore, the conventional conversion into a different language is carried out by converting documents into digital images through a scanner, recognizing characters by use of a character recognition software installed in a personal computer (PC), and converting the recognized characters into a different language through a conversion program.

FIG. 1A is a view illustrating conventional procedures of converting one language into another by way of an example. Referring to FIG. 1A, documents 1 in Korean to be translated are scanned into digital images by use of a scanner 2. Next, an optical character reader (OCR) provided together with the scanner 2 or a character recognition program installed in a host PC 3 divides the images into text and non-ext parts depending on whether characters can be recognized or not, and recognizes the text parts from which characters can be recognized. Finally, the recognized characters are translated into a different language by use of a translation program. If translated documents 5 need to be printed, the translated documents 5 are output through a printer 4 separately provided, and, if the translated documents 5 need to be faxed, the translated documents 5 output from the printer 4 are faxed through a facsimile machine 6 separately provided.

On the other hand, in the same way as the translation into a different language, the conventional conversion into a voice is carried out by converting documents into digital images through a scanner, recognizing characters by use of a character recognition program installed in a PC, and converting the recognized characters into a voice by use of a voice conversion program.

FIG. 1B is a view illustrating a conventional voice conversion process by way of an example. Referring to FIG. 1B, the scanner 2 is used to convert into digital images the documents 1 to be converted into a voice, for example, the documents received or transmitted through the facsimile machine 6 or the documents output from the printer 4.

The OCR provided together with the scanner or the character recognition program installed in the PC 3 is used to divide the digital images into text and non-text parts depending on whether characters can be recognized, and then to recognize the text parts from which characters can be recognized. Next, a voice conversion program is used to convert the recognized characters into the voice output through a speaker 7.

The conventional language translation and voice conversion methods as above have a problem in that devices such as the scanner 2, host PC 3, printer 4, facsimile machine 6, and so on are separately equipped and a user himself has to do the tasks step by step.

Furthermore, the language translation method has a problem of inefficient process since the repetitive tasks in digital and analog formats are involved such as scanning documents printed on paper into digital images, printing the digital images onto paper, and converting data printed on paper into digital images to be faxed.

Furthermore, the conversion to the voice from documents received and transmitted through the facsimile machine 6 or photocopied through a photocopier has a problem of an inefficient process since digital images have to be obtained through scanning after the printout of the documents even though the same digital images have been obtained for fax transmission and reception, and photocopying.

### SUMMARY OF THE INVENTION

The present general inventive concept provides a combination machine having an image data conversion function and an image data conversion method therefor, capable of translating documents into a different language, converting the documents into an image displayable on an external display device, and converting the documents into voice data according to a user's single command so that the translation and/or conversion process is simplified and the task efficiency is enhanced, wherein the combination machine refers to a device into which a scanner, a printer, a photocopier, and a facsimile machine are incorporated.

Additional aspects and advantages of the present general inventive concept will be set forth in part in the description which follows and, in part, will be obvious from the description, or may be learned by practice of the general inventive concept.

The forgoing and/or other aspects and advantages may be achieved by providing a combination machine having an image data conversion function, comprising a character recognition part to recognize characters on the images; a translation part to translate the recognized characters into a different language; and a controller to control the character recognition part and the translation part to translate the images into the different language and to convert the characters translated in the different language into the images, wherein the combination machine has at least two modules among a scanner module to project light onto documents and produce images, a photocopier module to output to output images onto paper, a printer module to print images received externally on paper, and a facsimile machine module to send the images through a communication channel and to receive the images through the communication channel.

The combination machine may further comprise a host personal computer (PC) interface to receive the characters from a host PC, wherein the controller controls the translation part to translate the received characters into the different language.

The forgoing and/or other aspects and advantages may also be achieved by providing an image data conversion method of a combination machine having an image data conversion function, the method comprising recognizing characters on images; translating the recognized characters into a different language; and converting the characters translated in the different language into images, wherein the combination machine has at least two modules among a scanner module to project light onto documents and produce images, a photocopier module to output images onto paper, a printer module to print images received externally on paper, and a facsimile machine module to send images through a communication channel and to receive images through the communication channel.

The image data conversion method may further comprise interfacing with a host PC from which the characters are received; translating the received characters into the different language; and converting the translated characters into the images.

The forgoing and/or other aspects and advantages may also be achieved by providing a host PC having an image data conversion function and driving a combination machine, the host PC comprising an input and output (I/O) interface to receive images from the combination machine; a combination machine driver to drive the combination machine and to translate the received images into a different language; and a host PC controller to control the I/O interface and the combination machine driver to translate the received images into the different language and to process characters translated in the different language in the combination machine, wherein the combination machine has at least two modules among a scanner module to project light onto documents and produce images, a photocopier module to output images onto paper, a printer module to print images received externally on paper, and a facsimile machine module to send images through a communication channel and to receive the images through the communication channel.

The combination machine driver may include a character recognition part to recognize characters on the images; and a translation part to translate the recognized characters into the different language.

The forgoing and/or other aspects and advantages may also be achieved by providing a combination machine having an image data conversion function, the combination machine comprising a character recognition part to recognize characters on images; a voice conversion part to convert the recognized characters into a voice signal; a voice recording part to record the converted voice signal onto a predetermined recording medium; and a controller to control the character recognition part, the voice conversion part, and the voice recording part to convert the images into the voice signal and to record the voice signal onto the recording medium, wherein the combination machine has at least two modules among a scanner module to project light onto documents and produce images, a photocopier module to output images onto paper, a printer module to print images received externally on paper, and a facsimile machine module to send images through a communication channel and to receive images through the communication channel,.

The combination machine may further comprise a host PC interface to receive the characters from a host PC, wherein the controller controls the voice conversion part to convert the received characters into the voice signal.

In The forgoing and/or other aspects and advantages may also be achieved by providing an image data conversion method of a combination machine comprising recognizing characters on images; converting the recognized characters into a voice signal; and recording the converted voice signal onto a predetermined recording medium, wherein the combination machine has at least two modules among a scanner module to project light onto documents and produce images, a photocopier module to output images onto paper, a printer module to print images received externally on paper, and a facsimile machine module to send the images through a communication channel and to receive the images through the communication channel.

The image data conversion method may further comprise receiving the characters from a host PC; and converting the received characters into the voice signal.

The forgoing and/or other aspects and advantages may also be achieved by providing a host PC to drive a combination machine, the host PC comprising an I/O interface to receive images from the combination machine; a combination machine driver to drive the combination machine and to convert the received images into a voice signal; a voice recording part to record the converted voice signal onto a predetermined recording medium; and a host PC controller to control the I/O interface and the combination machine driver to convert the received images into the voice signal and to record the voice signal onto the recording medium, wherein the combination machine has an image data conversion function, the combination machine having at least two modules among a scanner module to project light onto documents and produce images, a photocopier module to output images onto paper, a printer module to print images received externally on paper, and a facsimile machine module to send images through a communication channel and to receive images through the communication channel.

The combination machine driver may include a character recognition part to recognize characters on the received images; and a voice conversion part to convert the recognized characters into a voice signal.

The forgoing and/or other aspects and advantages may also be achieved by providing an image data conversion method of a host PC driving a combination machine, the method comprising receiving the images from a combination machine; converting the received images into a voice signal; and recording the converted voice signal onto a predetermined recording medium, wherein the combination machine has at least two modules among a scanner module to project light onto documents and produce images, a photocopier module to output images onto paper, a printer module to print images received externally on paper, and a facsimile machine module to send images through a communication channel and to receive images through the communication channel.

The converting of the received images may include recognizing characters on the images; and converting the recognized characters into the voice signal.

The forgoing and/or other aspects and advantages may also be achieved by providing a combination machine having an image data conversion function and connected to an external display device, the combination machine having at least two modules among a scanner module to project light onto documents and produce images, a photocopier module to output images onto a paper, a printer module to print images received externally on paper, and a facsimile machine module to send images through a communication channel and to receive images through the communication channel, the combination machine comprising a character recognition part to recognize characters on images; a translation part to translate the recognized characters into a different language; an image conversion part to convert the translated characters into an image format displayable on an external display device; and an image storage part to store the converted images.

The combination machine may further comprise an image output part to output the image stored in the image storage part to the external display device.

The forgoing and/or other aspects and advantages may also be achieved by providing an image data conversion method of a combination machine having an image data conversion function and connected to an external display device, the combination machine having at least two modules among a scanner module to project light onto documents and produce images, a photocopier module to output images onto paper, a printer module to print images received externally on paper, and a facsimile machine module to send images through a communication channel and to receive images through the communication channel, the method comprising recognizing characters on images; translating the recognized characters into a different language; converting the translated characters into an image format displayable on the external display device; and recording the converted images.

The image data conversion method may further comprise outputting the image recorded in the image storage part to the external display device.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A is a view illustrating a conventional process of translation into a different language;

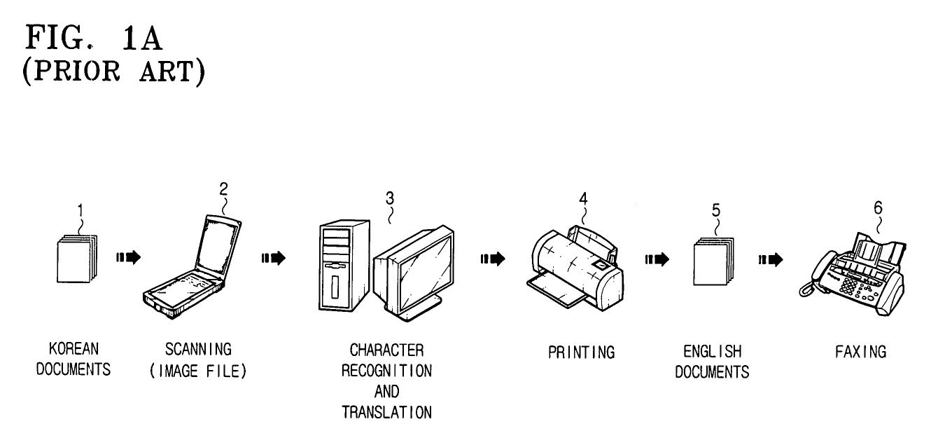

FIG. 1B is a view illustrating a conventional process of conversion into a voice;

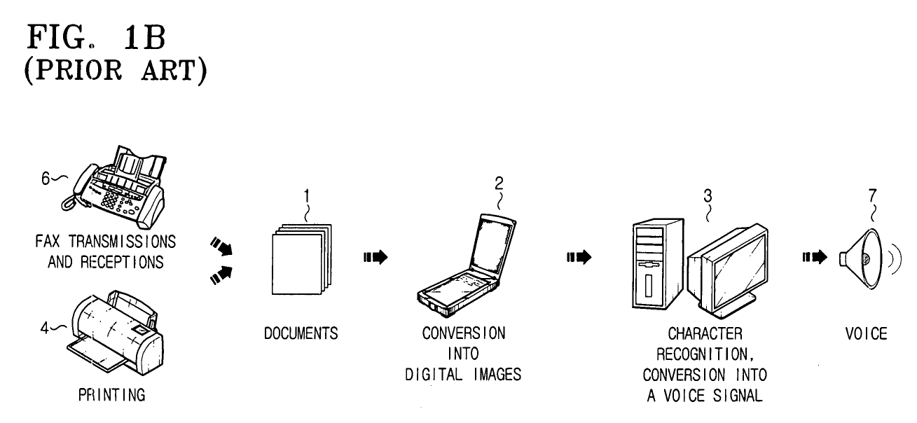

FIG. 2 is a block diagram illustrating a combination machine having a function of translating image data into a different language according to an embodiment of the present general inventive concept;

FIG. 3 is a flowchart illustrating operations of the combination machine having the function of translating the image data into the different language as shown in FIG. 2;

FIG. 4 is a block diagram illustrating a combination system having a function of translating image data into a different language according to another embodiment of the present general inventive concept;

FIG. 5 is a flowchart illustrating operations of the combination system having the function of translating the image data into the different language as shown in FIG. 4;

FIG. 6 is a block diagram illustrating a combination machine having a function of converting image data into a voice signal according to yet another embodiment of the present general inventive concept;

FIG. 7 is a flowchart illustrating operations of the combination machine having the function of converting the image data into the voice signal as shown in FIG. 6;

FIG. 8 is a block diagram illustrating a combination system having a function of converting image data into a voice signal according to still another embodiment of the present general inventive concept;

FIG. 9 is a flowchart illustrating operations of the combination system having the function of converting the image data into the voice signal as shown in FIG. 8;

FIG. 10 is a block diagram illustrating a combination machine having an image conversion function after translating into a different language according to another embodiment of the present general inventive concept; and

FIG. 11 is a flowchart illustrating operations of the combination machine of FIG. 10.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

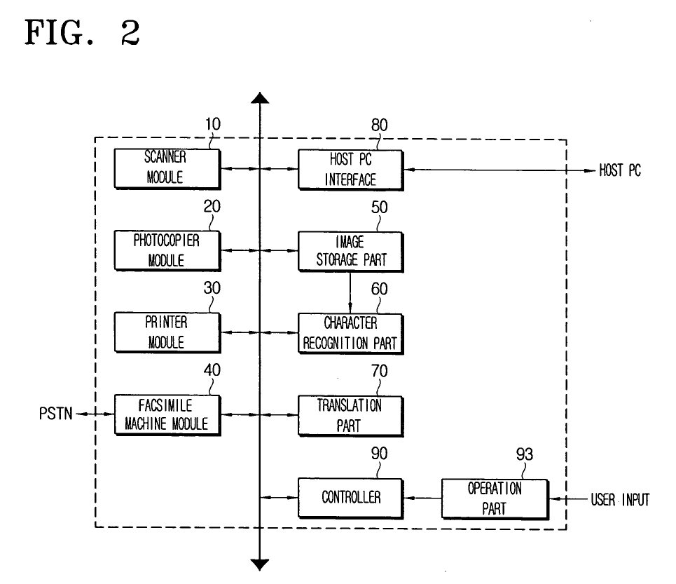

FIG. 2 is a block diagram illustrating a combination machine having a function of translating image data into a different language according to an embodiment of the present general inventive concept. Referring to FIG. 2, the combination machine may include a scanner module 10, a photocopier module 20, a printer module 30, a facsimile machine (or fax) module 40, an image storage part 50, a character recognition part 60, a translation part 70, a host PC interface part 80, a controller 90, and an operation part 93.

The scanner module 10 projects light onto documents, and converts light reflected from the documents into an electric signal, that is, digital images, through a sensor such as a charge coupled device (CCD) or a contact image sensor (CIS).

The photocopier module 20 outputs onto paper the digital images produced through the scanner module 10.

The printer module 30 receives a signal from a host PC, processes the signal into digital images, and outputs the digital images onto paper.

The fax module 40 transmits through a communication channel the digital images obtained from the scanner module 10, and receives and outputs the images through the communication channel, and the fax module 40 can be structured with an interface circuit to interface the scanner module 10 and public switched telephone network (PSTN).

The image storage part 50 stores the digital images produced from the scanner module 10, the photocopier module 20, the printer module 30, and the fax module 40.

The character recognition part 60 divides the images stored in the image storage part 50 into character-recognizable sections (text sections) and character-unrecognizable sections (non-text sections), and recognizes characters on the text sections. Here, the character recognition part 60 may be an optical character reader (OCR).

The translation part 70 translates data recognized as characters by the character recognition part 60 into a different language selected by a user. Here, the available languages for translation can be added when the combination machine is upgraded.

The operation part 93 may include a key panel (not shown) having keys to enable a user to operate the scanner module 10, the photocopier module 20, the printer module 30, and the fax module 40, and keys to enable a user to operate a function of translation into a different language, and a display window (not shown) to display states of the combination machine. The display window can display an option menu to enable a user to select a language of original documents before the original documents are translated and a foreign language to translate the documents thereto (hereinafter, referred to as a target language) when the user presses a key reserved for the function of translation into a different language, and the options can be updated when available languages of translation are added. The display window may be constructed with an LCD, LED, or touch screen.

The controller 90 controls the overall operations of the combination machine according to programs.

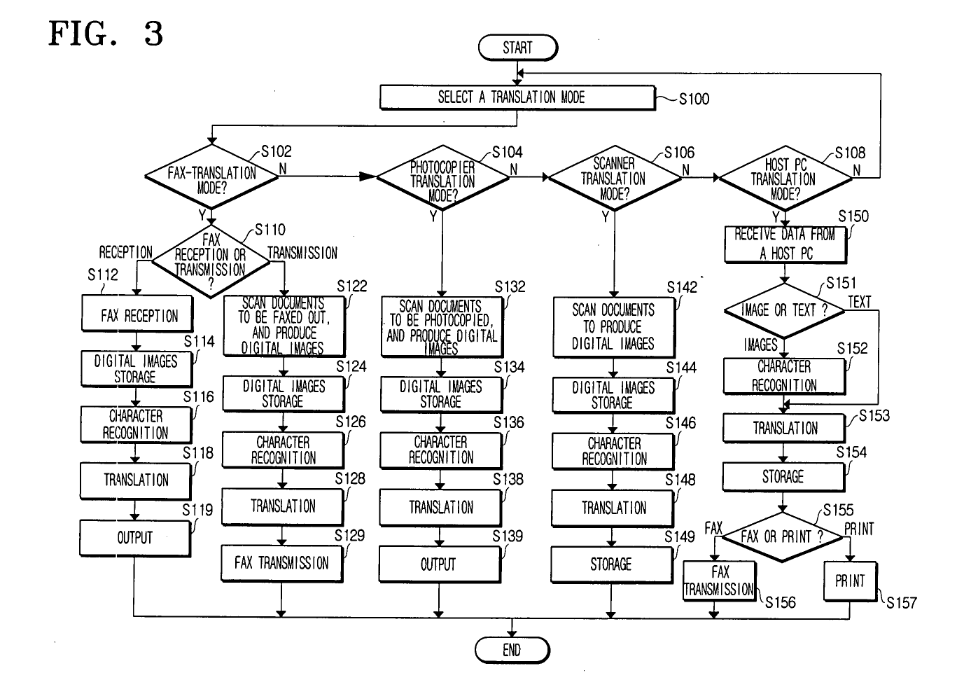

FIG. 3 is a flowchart illustrating operations of the combination machine having the function of translating the image data into the different language as shown in FIG. 2. Referring to FIGS. 2 and 3, a user can select on the operation part 93 any one of a fax translation mode to translate received and transmitted fax documents, a photocopier translation mode to translate photocopied documents, a scanner translation mode to translate scanned documents, and a host PC translation mode to translate data received from the host PC (operation S100).

In the operation S100, the user checks whether the fax translation mode is selected (operation S102) and, if selected the user selects a fax-reception translation mode or a fax-transmission translation mode (operation S110). If the fax-reception translation mode is selected, the combination machine receives fax documents (operation S112), and stores digital images, which are the received fax data, into the image storage part 50 (operation S114), and the character recognition part 60 recognizes characters or text (operation S116), and the translation part finally translates the recognized characters into the language to which the user has set (operation S118). Next, the translated documents are output (operation S119). The translated documents may be output together with the original documents.

If the fax-transmission translation mode is selected, the scanning module 10 scans the fax documents to be transmitted, and produces digital images (operation S122). The subsequent operations S124, S126, and S128 are the same as operations S114, S116, and S118 described above. Furthermore, the translation part 70 translates the recognized characters (operation S128), and the translated documents are faxed out through the public switched telephone network (PSTN) (operation S129).

If the fax-translation mode is not selected in operation S102, the combination machine checks whether the photocopier-transmission translation mode is selected (operation S104). If the photocopy translation mode is selected, the photocopier module 20 scans the documents to be photocopied to create digital images (operation S132), and can photocopy and output the original documents. The subsequent operations S134, S136, and S138 are the same as operations S114, S116, and S118 described above. Next, the combination machine outputs the translated documents (operation S139).

If the photocopier translation mode is not selected in operation S104, the combination machine checks if the scanner translation mode is selected (operation S106). If the scanner translation mode is selected, the scanner module is used to scan the original documents and create digital images (operation S142), and the subsequent operations S144, S146, and S148 are the same as operations S114, S116, and S118 described above. Further, the translated documents can be stored in a predetermined storage part (operation S149), and can be output if set by the user to do so.

If the scanner translation mode is not selected in operation S106, the combination machine checks whether the host PC translation mode is selected (operation S108). If the host PC translation mode is selected, data to be translated is received from a host PC (operation S150). The combination machine checks whether the received data is in a text format or in a digital image format (operation S151). If in the digital image format, the character recognition part 60 recognizes the characters that it can recognize (operation S152). Next, the translation part 70 translates the recognized characters, that is, text, into a language that the user has selected (operation S153). If the received data is determined to be in the text format in operation S151, the character recognition part 60 translates the text into a language that the user has selected (operation S153). The translated data can be stored at a predetermined storage part (operation S154), and if the user wants the translated data to be faxed or printed (operation S155), the translated data can be processed into images and faxed by the fax module 40 (operation S156) or printed by the printer module 30 (operation S157).

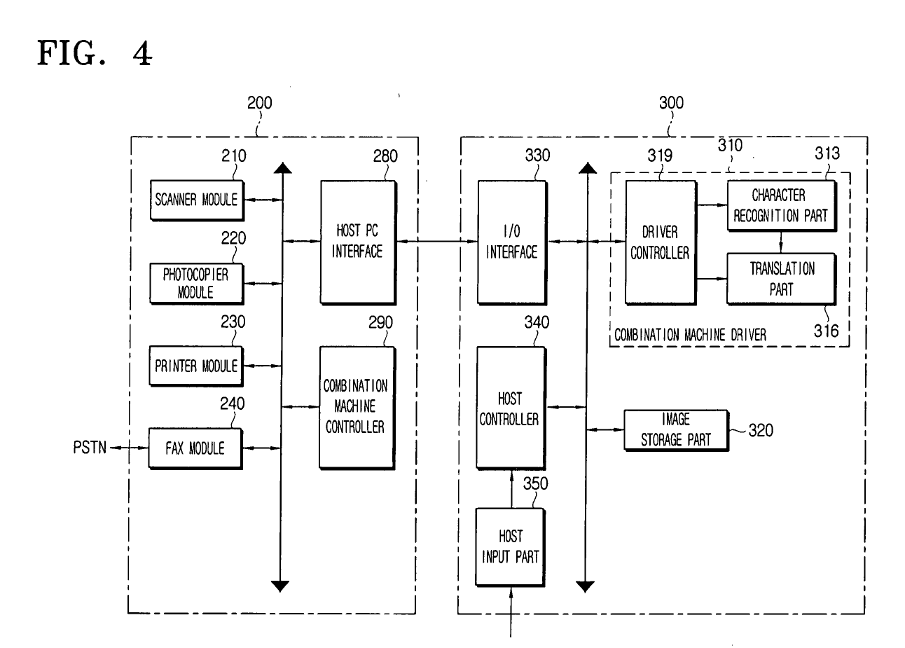

FIG. 4 is a block diagram illustrating a combination system having a function of translating image data into a different language according to another embodiment of the present general inventive concept. Referring to FIG. 4, the combination system may include a combination machine 200 and a host PC 300.

The combination machine 200 of the combination system of FIG. 4 may include a scanner module 210, a photocopier module 220, a printer module 230, a fax module 240, a host PC interface 280, and a combination machine controller 290.

The scanner module 10, photocopier module 20, printer module 30, and fax module 40 shown in FIG. 2 can be used for the scanner module 210, photocopier module 220, printer module 230, and fax module 240, respectively.

The host PC interface 280 interfaces with the host PC 300 to allow smooth communications, and the combination machine controller 290 controls individual components of the combination machine 200 and drives the combination machine 200.

The host PC 300 may include a combination machine driver 310, an image storage part 320, an I/O interface 330, a host PC controller 340, and a host input part 350.

The combination machine driver 310 controls the combination machine 200 to be driven normally under an operating system of the host PC 300, and interfaces with a user. Further, the combination machine driver 310 may include a character recognition part 313 to recognize characters on images, a translation part 316 to translate the recognized characters into a language that the user has selected, and a driver controller 319 to control the entire driving of the combination machine driver 310. Menu windows can be provided so that the user can select a target language into which the recognized characters can be translated, and the available languages of translation can be added when the combination machine 200 is upgraded.

The image storage part 320 receives and stores digital images from the combination machine 200, and provides the character recognition part 313 with the digital images from which the characters are recognized.

The I/O interface 330 interfaces with the combination machine 200 to allow smooth communications.

The host controller 340 controls the individual components of the host PC 300, receives a user's input instructing the combination machine 200 to carry out translations, drives the combination machine driver 310, and controls the driving of a corresponding module of the combination machine 200.

The host input part 350 can be provided with keys to control the combination machine 200, including a key to translate into a different language.

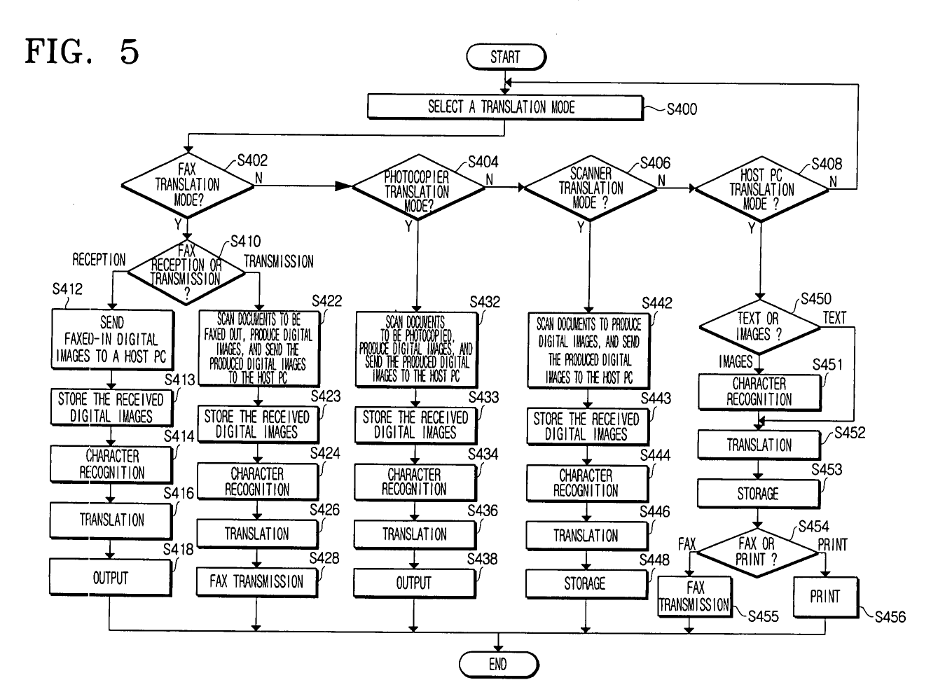

FIG. 5 is a flowchart illustrating operations of the combination machine system having the function of translating the image data into the different language as shown in FIG. 4. Referring to FIGS. 4 and 5, a user can select a translation mode by use of the host input part 350 (operation S400).

The combination machine 200 checks whether the fax-translation mode is selected in the operation S400 (operation S402), and, if the fax-translation mode is selected, the combination machine 200 checks whether the fax-reception translation mode or the fax-transmission translation mode is selected (operation S410). If the fax-reception translation mode is selected, the combination machine 200 receives fax documents in a digital image format, and transmits the received digital images to the host PC 300 (operation S412). The host PC 300 stores the received digital images in the image storage part 320 (operation S413). The character recognition part 313 of the combination machine driver 310 recognizes characters on the stored digital images (operation S414), the translation part 316 translates the recognized characters (operation S416). Next, the combination machine driver 310 controls the combination machine 200 to print translated documents onto paper (operation S418). The fax module 210 of the combination machine 200 may output the translated documents together with the received original fax documents.

If the fax-transmission mode is selected in operation S410, the combination machine 200 scans fax documents, and transmits the scanned fax documents in a form of digital images, to the host PC 300 (operation S422). Subsequent operations S423, S424, and S426 are the same as operations S413, S414, and S416, and, in the next step, the fax module 240 faxes the translated documents (operation S428). Further, the original documents before translated can be faxed together with the translated document when a certain key is selected.

If the fax translation mode is not selected in operation S402, the combination machine 200 checks whether the photocopier translation mode is selected (operation S404), and, if the photocopier translation mode is selected, the photocopier module 220 scans documents loaded to be photocopied, creates digital images, and can photocopy and output the original documents. Furthermore, the photocopier module 220 sends the created digital images to the host PC 300 (operation S432). Subsequent operations S433, S434, and S436 are the same as operations S413, S414, and S416, and the photocopier module 220 outputs the translated documents onto paper (operation S438).

If the photocopier translation mode is not selected in operation S404, the combination machine checks whether the scanner translation mode is selected (operation S406). If the scanner translation mode is selected, the scanner module S210 is used to scan the original documents and create digital images, and sends the created digital images to the host PC (operation S422). Further, the created digital images can be stored in a memory of the host PC designated by the user.

Subsequent operations S443, S444, and S446 are the same as operations S413, S414, and S416, and the translated documents are stored in a certain memory of the host PC (operation S448).

If the scanner translation mode is not selected in operation S406, the combination machine 200 checks whether the host PC translation mode is selected (operation S408). If the host PC translation mode is selected, that is, if the host PC translation mode is selected to translate data stored in the host PC 300, the host PC 300 determines whether the data to be translated is in a text format or in an image format (operation S450). If the data to be translated is in the image format, the character recognition part 313 recognizes characters on the images (operation S451), the translation part 316 translates the characters (operation S452), and stores the translated data in a certain memory (operation S453). On the other hand, if the data to be translated is in the text format in operation S450, the translation part 316 translates the data without an extra character recognition step (operation S452). The translated documents are stored in the memory (operation S453), and, if the user wants the translated data to be faxed or printed (operation S454), the translated data in storage can be sent to the combination machine 200 to be faxed (operation S455) or printed (operation S456).

The process as stated above enables the user to conveniently obtain, output, and receive and transmit the documents translated in a different language.

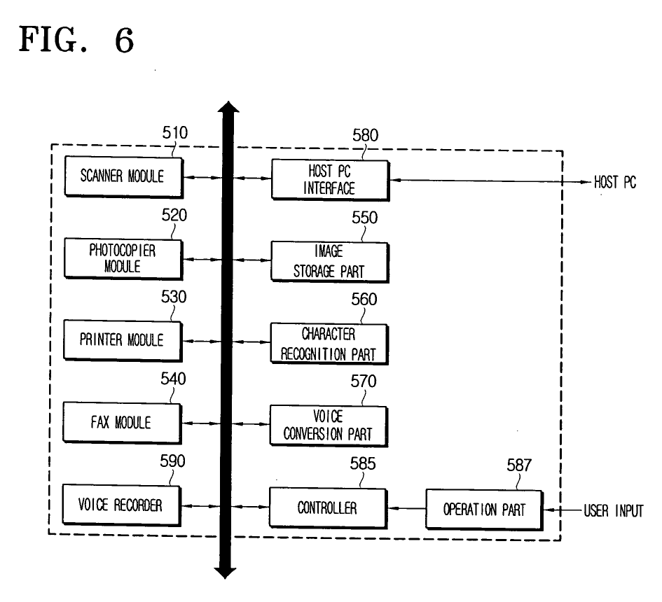

FIG. 6 is a block diagram illustrating a combination machine having a function of converting image data into a voice signal according to yet another embodiment of the present general inventive concept. Referring to FIG. 6, the combination machine may include a scanner module 510, a photocopier module 520, a printer module 530, a fax module 540, an image storage part 550, a character recognition part 560, a voice conversion part 570, a host PC interface 580, a controller 585, an operation part 587, and a voice recorder 590.

The scanner module 510 projects light onto documents, and the light is reflected from the documents. A sensor such as the CCD or CIS converts the reflected light into an electric signal, that is, digital images.

The photocopier module 520 outputs the converted digital images on paper through the scanner module 510.

The printer module 530 processes a signal from the host PC into digital images, and prints the digital images onto paper.

Further, the fax module 540 sends through a communication channel the digital images produced by the scanning module 510, receives and outputs the images through the communication channel, and can be constructed with a circuit interfacing with the scanner module 510 and the public switched telephone network (PSTN).

The image storage part 550 stores digital images produced by the scanner module 510, photocopier module 520, printer module 530, and fax module 540.

The character recognition part 560 divides the images stored in the image storage part 550 into character-recognizable parts and character-unrecognizable parts, and recognizes characters on the character-recognizable parts. In here, the character recognition part can be an optical character reader (OCR).

The voice conversion part 570 converts into a voice signal data recognized as characters by the character recognition part 560.

The voice recorder 590 records the converted voice signal onto a certain recording medium. In here, the voice recorder 590 can be any of a USB storage device, a CD recording medium, and a floppy disc drive that enables mass storage, and the recording medium can be a memory stick, a CD, a floppy disc, or the like.

The controller 585 controls the overall operations of the combination machine according to a main program to control the combination machine.

The operation part 587 can be provided with a key panel (not shown) having keys to enable a user to operate the scanner module 510, photocopier module 520, printer module 530, and fax module 540 and a key to enable the user to select a voice conversion mode, and a display window (not shown) to display states of the combination machine. In here, the display window may be formed of an LCD, LED, or touch screen.

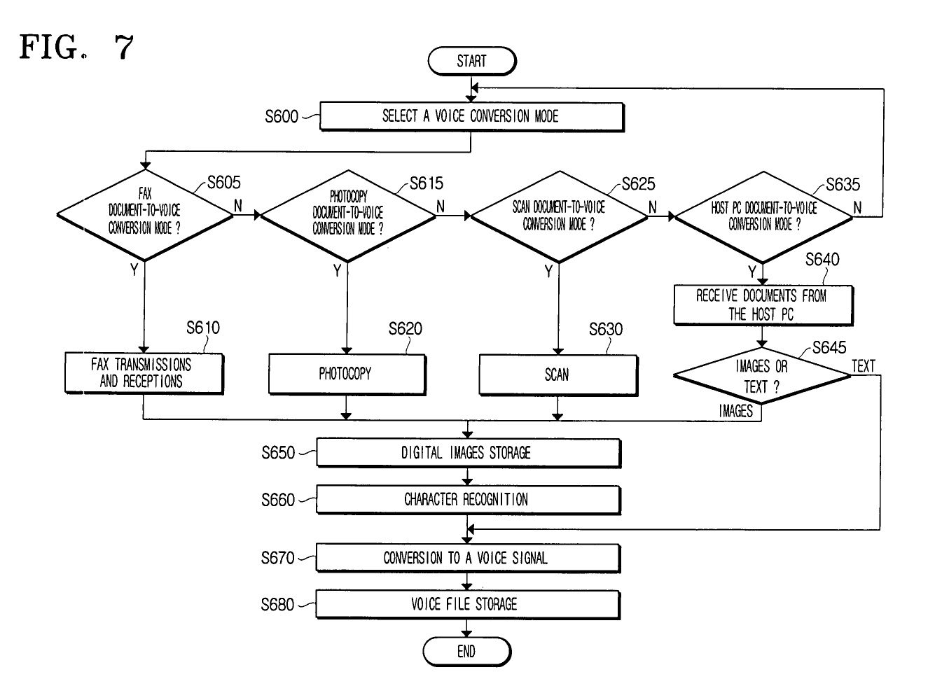

FIG. 7 is a flowchart illustrating operations of the combination machine having the function of converting the image data into the voice signal as shown in FIG. 6. Referring to FIGS. 6 and 7, a user selects a voice conversion mode on the operation part 587 (operation S600). The voice conversion mode includes a fax document-to-voice conversion mode to convert fax-reception and transmission data into a voice signal, a photocopy document-to-voice conversion mode to convert photocopied documents into a voice signal, a scan document-to-voice conversion mode to convert scanned documents into a voice signal, and a host PC document-to-voice conversion mode to convert documents received from a host PC into a voice signal.

The combination machine checks whether the fax document-to-voice conversion mode is selected in operation S600 (operation S605), and, if the fax document-to-voice conversion mode is selected, the combination machine checks whether a fax-transmission mode or a fax-reception mode is selected. If the fax-reception mode is selected, the combination machine receives fax documents through the fax module 510, and, if the fax-transmission mode is selected, the combination machine transmits fax documents (operation S610), the combination machine stores in the image storage part 550 the digital image data, being the fax-received data or the digital images produced when faxed out (operation S650).

If the fax document-to-voice conversion mode is not selected in operation S605, the combination machine checks whether the photocopy document-to-voice conversion mode is selected (operation S615). If the photocopy document-to-voice conversion mode is selected, the combination machine photocopies the documents (operation S620), and stores the digital images created upon the photocopy into the image storage part 550 (operation S650).

If the voice conversion mode is not selected in operation S615, the combination machine checks whether the scan document-to-voice conversion mode is selected (operation S625). If the scan document-to-voice conversion mode is selected, the combination machine creates digital images through scanning (operation S630), stores the digital images in a certain memory of the host PC as well as in the image storage part 550 (operation S650).

If the digital images have been stored in the image storage part 550 with respect to the fax document-to-voice conversion mode, photocopy document-to-voice conversion mode, and scan document-to-voice conversion mode (operation S650), the character recognition part 560 recognizes characters on the stored digital images (operation S660), and the voice conversion part 570 converts the characters recognized by the character recognition part 560 into a voice signal (operation S670).

Next, the converted voice signal is stored in a certain recording medium through the voice recorder 590 (operation S680).

If the scan document-to-voice conversion mode is not selected in operation S625, the combination machine checks whether the host PC document-to-voice conversion mode is selected (operation S635). If the host PC document-to-voice conversion mode is selected, the combination machine receives data from the host PC (operation S640). The combination machine then checks whether the data received from the host PC is in an image format or in a text format (operation S645), and, if in the image format, the combination machine stores the data in the image storage part 550 (operation S650), recognizes characters through the character recognition part 560 (operation S660), and converts the recognized characters into voice through the voice conversion part 570 (operation S670). If in the text format, the combination machine directly converts the recognized characters into voice through the voice conversion part 570 (operation S670). Next, the converted voice signal is recorded on a certain recording medium through the voice recorder 590 (operation S680).

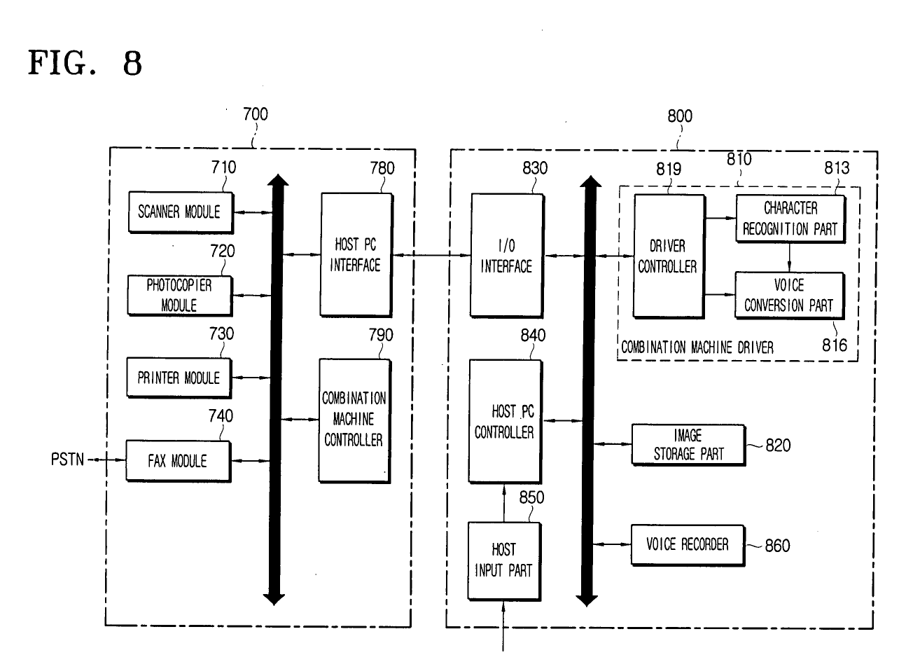

FIG. 8 is a block diagram illustrating a combination machine system having a function for converting image data into a voice signal according to still another embodiment of the present general inventive concept. Referring to FIG. 8, the combination machine system may have a combination machine 700 and a host PC 800.

The combination machine 700 may have a scanner module 710, a photocopier module 720, a printer module 730, a fax module 740, a host PC interface 780, and a combination machine controller 790.

It is possible to use the scanner module 10, photocopier module 20, printer module 30, and fax module 40 shown in FIG. 2 for the scanner module 710, photocopier module 720, printer module 730, and fax module 740, respectively.

The host PC interface 780 interfaces with the host PC 800 to allow smooth communications, the combination machine controller 790 controls individual components of the combination machine 700 and drives the combination machine 700.

The host PC 800 may include a combination machine driver 810, an image storage part 820, an I/O interface 830, a host PC controller 840, a host input part 850, and a voice recorder 860.

The combination machine driver 810 controls the combination machine 700 to normally drive under an operating system of the host PC 800, and interfaces with a user. Further, the combination machine driver 810 may include a character recognition part 813 to recognize characters on images, a voice conversion part 816 to convert the recognized characters into a voice signal, and a driver controller 819 to control the overall driving of the combination machine driver 810.

The voice recorder 860 records the voice signal converted by the voice conversion part 816 of the combination machine driver 810. Here, the voice recorder 860 can be any of a USB storage device, a CD recording medium, and a floppy disc drive that are for mass storage, and the recording medium can be a memory stick, a CD, or a floppy disc.

The image storage part 820 receives and stores digital images from the combination machine 700, and provides the digital images to the character recognition part 813 for character recognition.

The I/O interface 830 interfaces with the combination machine 700 to allow smooth communications.

The host controller 840 controls the individual components of the host PC 800 in order for the combination machine 700 to be driven smoothly.

The host input part 850 controls the host PC 800, and can be provided with keys reserved to drive the scanner module 710, photocopier module 720, printer module 730, and fax module 740 and keys reserved to select a voice conversion mode.

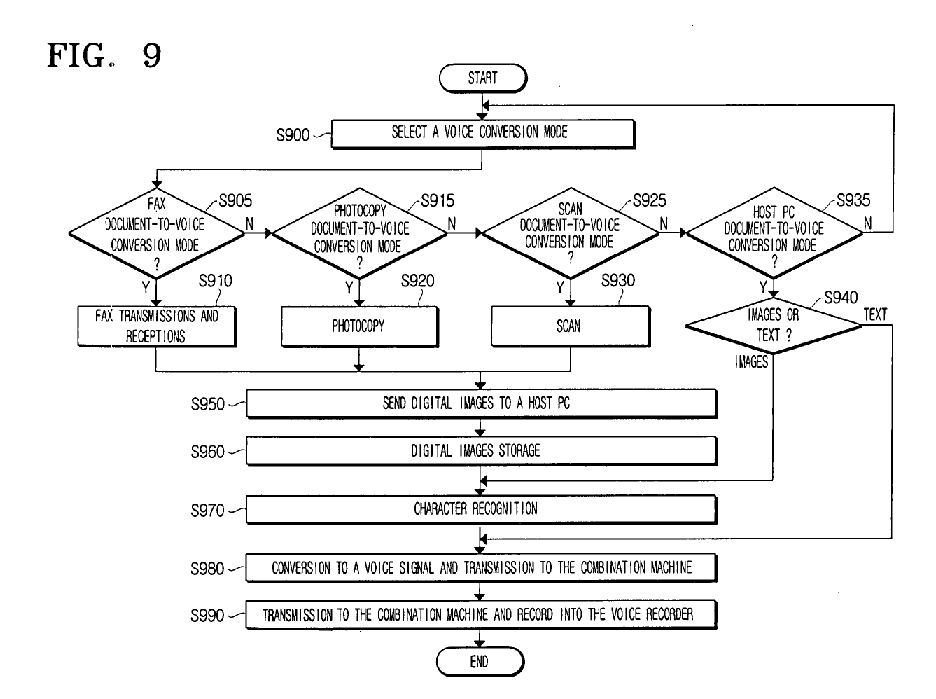

FIG. 9 is a flowchart illustrating the operations of the combination machine system having the function of converting the image data into the voice signal as shown in FIG. 8. Referring to FIGS. 8 and 9, a user can select a voice conversion mode (operation S900). The voice conversion modes include a fax document-to-voice conversion mode to convert fax-reception/transmission data into a voice signal, a photocopy document-to-voice conversion mode to convert photocopy documents into a voice signal, a scan document-to-voice conversion mode to convert scanned documents into a voice signal, and a host PC document-to-voice mode to convert into a voice signal documents received from the host PC 800.

The combination machine system checks whether the fax document-to-voice conversion mode is selected in operation S900 (operation S905). If the fax document-to-voice conversion mode is selected, the combination machine system checks whether the fax-transmission mode or the fax-reception mode is selected, and, if the fax-reception mode is selected, the combination machine system receives fax documents through the fax module 710, and, if the fax-transmission mode is selected, the combination machine system transmits fax documents, and sends to the host PC 800 digital images being the fax-received data or a digital image created when faxed out (operation S950).

If the fax document-to-voice conversion mode is not selected in operation S905, the combination machine system checks whether the photocopy document-to-voice conversion mode is selected (operation S915). If the photocopy document-to-voice conversion mode is selected, the combination machine system photocopies documents (operation S920), and sends to the host PC 800 the digital images produced when the documents are photocopied (operation S950).

If the photocopy document-to-voice conversion mode is not selected in operation S915, the combination machine system checks whether the scan document-to-voice conversion mode is selected (operation S925). If the scan document-to-voice conversion mode is selected, the combination machine system produces digital images by scanning (operation S930), sends the produced digital images to the host PC 800 (operation S950), records the digital images in a certain memory (not shown), and stores the digital images in the image storage part 820 of the host PC 800 (operation S960).

The character recognition part 813 of the combination machine driver 810 receives the digital images created in operations S910, S920, S930, and S940 (operation S950) and recognizes characters on the received digital images (operation S970), and the voice conversion part 816 converts the recognized characters into a voice signal (operation S980). Next, the converted voice signal is recorded on a certain recording medium by the voice recording part 860 (operation S990), and the voice signal can be also controlled to be stored in a certain memory of the combination machine 700.

If the scan document-to-voice conversion mode is not selected in operation S925, the combination machine system checks whether the host PC document-to-voice conversion mode is selected (operation S935). If the host PC document-to-voice conversion mode is selected, the combination machine system checks whether the data of the host PC for conversion is in an image format or in a text format (operation S940). If the data is in the text format, the combination machine system immediately converts the data into a voice signal (operation S980). If the data is in the image format, the combination machine driver 810 recognizes characters on the image (operation S970) and converts the recognized characters into a voice signal (operation S980). Next, the converted voice signal is recorded on a certain recording medium by the voice recorder 860 (operation S990), and the voice signal can be also controlled to be stored in a certain memory of the combination machine 700.

Through the above process, the user's simple manipulation enables the combination machine system to translate and convert documents into voice.

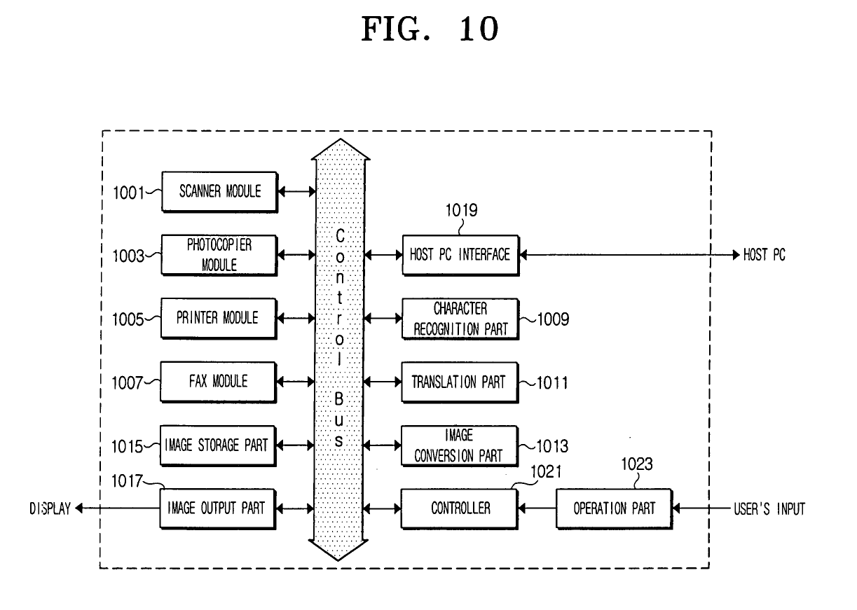

FIG. 10 is a block diagram illustrating a combination machine having an image conversion function after translating into a different language according another embodiment of the present general inventive concept. Referring to FIG. 10, the combination machine may include a scanner module 1001, a photocopier module 1003, a printer module 1005, a fax module 1007, a character recognition part 1009, a translation part 1011, an image conversion part 1013, an image storage part 1015, an image output part 1017, a host PC interface 1019, a controller 1021, and an operation part 1023.

The scanner module 1001 projects light onto documents, and the light is reflected from the documents. A sensor, such as a CCD or CIS, converts the reflected light into an electric signal, that is, into digital images.

The photocopier module 1003 outputs the digital images converted through the scanner module 1001 on a paper.

The printer module 1005 processes a signal from a host PC into digital images, and prints the digital images onto a paper.

The fax module 1007 sends through a communication channel the digital images produced by the scanning module 1001, receives and outputs the images through the communication channel. The fax module 1007 can include a circuit interfacing with the scanner module 1001 and the public switched telephone network (PSTN).

The character recognition part 1009 divides digital image images stored in the image storage part 1015 into character-recognizable parts and character-unrecognizable parts, and recognizes characters on the character-recognizable parts. The character recognition part 1009 can be an optical character reader (OCR).

The translation part 1011 translates data recognized as characters by the character recognition part 1009 into a different language selected by a user. The available languages for translation can be added when the combination machine is upgraded.

The image conversion part 1013 converts the translated characters into images displayable on an external display device. To this end, the image conversion part 1013 can overwrite the translated characters on a corresponding position in an original documents, and thus generate images translated into a different language. The image conversion part 1013 converts the translated image into an image format displayable by a external display device (hereinafter, referred to as a displayable image).

The image storage part 1015 stores the digital images produced from the scanner module 1001, the photocopier module 1003, the printer module 1005, and the fax module 1007, and the displayable images. The image storage part 1015 can be an external storage medium having a mass storage memory to store the displayable images, and an interface to transmit and receive data to and from the external display device. It is advantageous that the interface of the external storage medium may support a universal serial bus (USB). The image storage part 1015 can transfer the displayable images to the external display device in real-time by use of a streaming function.

The image output part 1017 outputs the displayable images stored in the image storage 1015 to the external display device. The image output part 1017 may include an image output terminal.

The host PC interface 1019 interfaces with the host PC to allow smooth communications. Data transferred from the host PC can include print data and a control instruction to control the scanner module 1001, the photocopier module 1003, and the fax module 1007. Especially, the transferred data include a control instruction to control the function of translating into a different language and the image conversion function.

The operation part 1023 can include a key panel (not shown) having keys to enable the user to operate the scanner module 1001, the photocopier module 1003, the printer module 1005, and the fax module 1007, and keys to enable the user to operate the translation function and the image conversion function, and a display window (not shown) to display states of the combination machine. The display window can display a menu to enable the user to select a language of original documents before the original documents are translated and a foreign language to translate the documents thereto when the user presses a key reserved for the translation function, and a menu to enable the user to operate an image conversion function such as storing and real-time transmission when the user selects the image conversion function. The display window may be constructed with a LCD, a LED, or a touch screen.

The controller 1021 controls the overall operations of the combination machine according to control programs.

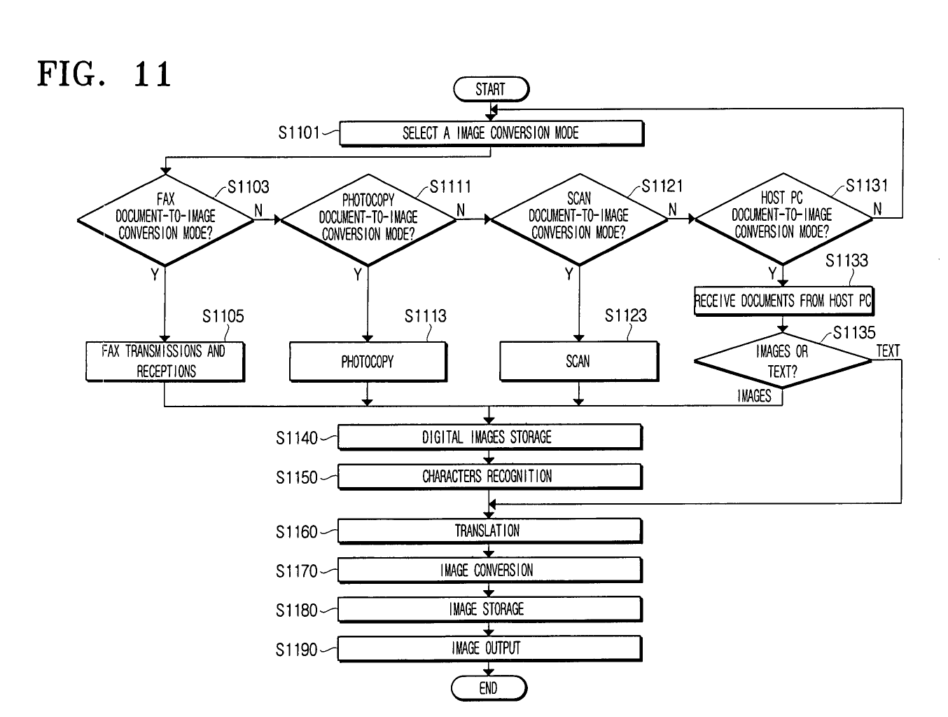

FIG. 11 is a flowchart illustrating operations of the combination machine of FIG. 10.

Referring to FIGS. 10 and 11, the user can select a mode for the translation and the image conversion by controlling the operation part 1023. The mode may be selected by the control instruction input from the host PC (operation S101).

The modes may include a fax document-to-image conversion mode to translate and convert data transmitted and received through the fax into displayable images, a photocopy document-to-image conversion mode to translate and convert photocopied documents into displayable images, a scan document-to-image conversion mode to translate and convert scanned documents into displayable images, and a host PC document-to-image conversion mode to translate and convert documents received from the host PC into displayable images.

The controller 1021 checks whether the fax document-to-image conversion mode is selected when the image conversion mode is selected through the operation part 1023 (operation S1103).

If the fax document-to-image conversion mode is selected, the controller 1021 checks whether the fax-transmission mode or the fax-reception mode is selected. If the fax-reception mode is selected, the controller 1021 receives images through the fax module 1007, and, if the fax-transmission mode is selected, the controller 1021 sends images through the fax module 1007 (operation S1105).

The controller 1021 stores in the image storage part 1015 digital images which are the fax-received images or digital images created when faxed out (operation S1140).

If the fax document-to-image conversion mode is not selected in operation S1103, the controller 1021 checks whether the photocopy document-to-image conversion mode is selected (operation S1111). If the photocopy document-to-image conversion mode is selected, the controller 1021 photocopies documents (operation S1113), and stores digital images created when photocopied in the image storage part 1015 (operation S1140).

If the photocopy document-to-image conversion mode is not selected in operation S1111, the controller 1021 checks whether the scan document-to-image conversion mode is selected (operation S1121). If the scan document-to-image conversion mode is selected, the controller 1021 produces digital images by scanning (operation S1123), records the digital images in a certain memory (not shown) of the host PC, and stores the digital images in the image storage part 1015 (operation S1140).

The character recognition part 1015 recognizes characters on the digital images corresponding to each of the fax document-to-image conversion mode, the photocopy document-to-image conversion mode, and the scan document-to-image conversion mode (operation S1150) if the digital images are stored in the image storage part 1015 (operation S1140). The translation part 1011 translates the recognized characters into a set language (operation S1160), and the image conversion part 1013 converts the translated characters to the displayable images (operation S1170). The converted displayable images are stored in the image storage part 1015 (operation S1180), and output to the external display device (operation S1190).

If the host PC document-to-image conversion mode is selected (operation S1131), the controller 1021 receives documents from the host PC through the host PC interface 1019 (operation S1133).

The controller 1021 checks whether the received documents are in a text format or in an image format (operation S1135). In a case of the image format, the controller 1021 proceeds to the operation S1140. In a case of the text format, the controller 1021 proceeds to the operation S1160 because the character recognition is not required.

Although the combination machines of FIGS. 2, 6 and 10 are illustrated respectively by functions, a single combination machine can include all the functions for the document translation, the voice conversion, and the image conversion.

Accordingly, the combination machine of FIG. 2 may include the voice conversion part 570 and the voice recorder 590 of FIG. 6, and the image conversion part 1013 and the image output part 1017 of FIG. 10.

As described above, the present general inventive concept enables documents to be translated and converted into a voice, and converted into images to be output to an external display device through user's simple manipulations by use of a combination machine into which a scanner, printer, photocopier, and a facsimile machine are incorporated.

The combination machine can be connected directly to the external display device without requiring an additional image processing device for the external display device. Thus, the images processed by the combination machine can be provided to the user.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A combination machine having an image data conversion function, the combination machine having at least two modules among a scanner module to project light onto a document and produce a first image, a photocopier module to output a second image onto paper, a printer module to print a third image received externally on paper, and a facsimile machine module to send a fourth image through a communication channel and to receive a fifth image through the communication channel, comprising:
a character recognition part to recognize one or more characters on at least one of the first, second, third, fourth, and fifth images;
a translation part to translate the recognized characters into a different language; and
a controller to control the character recognition part and the translation part to translate the image into the different language and to convert the characters translated in the different language into another image.

2. The combination machine as claimed in claim 1, further comprising a host personal computer (PC) interface to receive the characters from a host PC, wherein the controller controls the translation part to translate the received characters into the different language.

3. The combination machine as claimed in claim 1, further comprising an image storing part to store the at least one of the first, second, third, fourth, and fifth images and an operation part to allow a user to input information to the controller.

4. The combination machine as claimed in claim 1, wherein the character recognition part divides the at least one of the first, second, third, fourth, and fifth images into a character-recognizable section and a character-unrecognizable section.

5. The combination machine as claimed in claim 4, wherein the character recognition part recognizes the one or more characters from the character recognizable section.

6. The combination machine as claimed in claim 1, wherein the character recognition part comprises an optical character reader.

7. An image data conversion method for a combination machine having an image data conversion function, the combination machine having at least two modules among a scanner module to project light onto a document and produce a first image, a photocopier module to output a second image onto paper, a printer module to print a third image received externally on paper, and a facsimile machine module to send a fourth image through a communication channel and to receive a fifth image through the communication channel, comprising:
recognizing one or more characters on at least one of the first, second, third, fourth, and fifth images;
translating the recognized characters into a different language; and
converting the characters translated in the different language into a sixth image.

8. The image data conversion method as claimed in claim 7, further comprising:
interfacing with a host PC from which the characters are received;
translating the received characters into the different language; and
converting the translated characters into the sixth image.

9. A host PC having an image data conversion function and driving a combination machine having at least two modules among a scanner module to project light onto a document and produce a first image, a photocopier module to output a second image onto paper, a printer module to print a third image received externally on paper, and a facsimile machine module to send a fourth image through a communication channel and to receive a fifth image through the communication channel, comprising:
an input and output (I/O) interface to receive at least one of the first, second, third, fourth, and fifth images from the combination machine;
a combination machine driver to drive the combination machine and translating the received image into a different language; and
a host PC controller to control the I/O interface and the combination machine driver to translate the received image into the different language and to process one or more characters translated in the different language in the combination machine.

10. The host PC as claimed in claim 9, wherein the combination machine driver includes:
a character recognition part to recognize the one or more characters on the received image; and
a translation part to translate the recognized characters into the different language.

11. The host PC as claimed in claim 9, further comprising an image storage part to store the at least one of the first, second, third, fourth, and fifth images, and a host input part to allow a user to input information to the host PC controller.

12. A combination machine having an image data conversion function, the combination machine having at least two modules among a scanner module to project light onto a document and produce a first image, a photocopier module to output a second image onto paper, a printer module to print a third image externally on paper, and a facsimile machine module to send a fourth image through a communication channel and to receive a fifth image through the communication channel, comprising:
a character recognition part to recognize one or more characters on at least one of the first, second, third, fourth, and fifth images;
a voice conversion part to convert the recognized characters into a voice signal;
a voice recording part to record the converted voice signal onto a predetermined recording medium; and
a controller to control the character recognition part, voice conversion part, and voice recording part to convert the image into the voice signal and to record the voice signal onto the recording medium.

13. The combination machine as claimed in claim 12, further comprising a host PC interface to receive the one or more characters from a host PC, wherein the controller controls the voice conversion part to convert the received characters into the voice signal.

14. The combination machine as claimed in claim 12, further comprising an image storing part to store the at least one of the first, second, third, fourth, and fifth images and a operation part to allow a user to input information to the controller.

15. An image data conversion method of a combination machine having at least two modules among a scanner module to project light onto a document and produce a first image, a photocopier module to output a second image onto paper, a printer module to print a third image received externally on paper, and a facsimile machine module to send a fourth image through a communication channel and to receive a fifth image through the communication channel, comprising:
recognizing one or more characters on at least one of the first, second, third, fourth, and fifth images;
converting the recognized characters into a voice signal; and
recording the converted voice signal onto a predetermined recording medium.

16. The image data conversion method as claimed in claim 15, further comprising:
receiving the one or more characters from a host PC; and
converting the received characters into the voice signal.

17. A host PC to drive a combination machine having an image data conversion function, the combination machine having at least two modules among a scanner module to project light onto a document and produce a first image, a photocopier module to output a second image onto paper, a printer module to print a third image received externally on paper, and a facsimile machine module to send a fourth image through a communication channel and to receive a fifth image through the communication channel, comprising:
an I/O interface to receive at least one of the first, second, third, fourth, and fifth images from the combination machine;
a combination machine driver to drive the combination machine and to convert the received image into a voice signal;
a voice recording part to record the converted voice signal onto a predetermined recording medium; and
a host PC controller to control the I/O interface and the combination machine driver to convert the received image into the voice signal and to record the voice signal onto the recording medium.

18. The host PC as claimed in claim 17, wherein the combination machine driver includes:
a character recognition part to recognize one or more characters on the received image; and
a voice conversion part to convert the recognized characters into a voice signal.

19. The host PC as claimed in claim 17, further comprising an image storage part to store the at least one of the first, second, third, fourth, and fifth images and a host input part to allow a user to input information to the host PC controller.

20. An image data conversion method for a host PC driving a combination machine having at least two modules among a scanner module to project light onto a document and produce a first image, a photocopier module to output a second image onto paper, a printer module to print a third image received externally on paper, and a facsimile machine module to send a fourth image through a communication channel and to receive a fifth image through the communication channel, comprising:
receiving at least one of the first, second, third, fourth, and fifth images from the combination machine;
converting the received image into a voice signal; and
recording the converted voice signal onto a predetermined recording medium.

21. The image data conversion method as claimed in claim 20, wherein the images conversion step includes:
recognizing characters on the received image; and
converting the recognized characters into the voice signal.

22. A combination machine having an image data conversion function and connected to an external display device, the combination machine having at least two modules among a scanner module to project light onto a document and produce a first image, a photocopier module to output a second image onto paper, a printer module to print a third image on received externally on paper, and a facsimile machine module to send a fourth image through a communication channel and to receive a fifth image through the communication channel, comprising:
a character recognition part to recognize one or more characters on at least one of the first, second, third, fourth, and fifth images;
a translation part to translate the recognized characters into a different language;
an image conversion part to convert the translated characters into an image format displayable on an external display device; and
an image storage part to store the converted image.

23. The combination machine as claimed in claim 22, further comprising an image output part to output the converted image stored in the image storage part to the external display device.

24. The combination machine as claimed in claim 22, further comprising:
a controller to control the character recognition part, the translation part, and the image conversion part;
a host personal computer (PC) interface to receive the one or more characters from a host PC; and
an operation part to allow a user to input information to the controller.

25. An image data conversion method of a combination machine having an image data conversion function and connected to an external display device, the combination machine having at least two modules among a scanner module to project light onto a document and produce a first image, a photocopier module to output a second image onto paper, a printer module to print a third image received externally on paper, and a facsimile machine module to send a fourth image through a communication channel and to receive a fifth image through the communication channel, the image data conversion method comprising:
recognizing characters on at least one of the first, second, third, fourth, and fifth images;
translating the recognized characters into a different language;
converting the translated characters into an image format displayable on the external display device; and
recording the converted image.

26. The image data conversion method as claimed in claim 25, further comprising outputting the converted image recorded in the image storage part to the external display device.

27. A combination printing, scanning, copying, and faxing apparatus comprising:
a character recognition part to recognize characters on images;
a translation part to translate the recognized characters into a different language;
a conversion part to convert the translated characters into an outputable format; and
a controller to control the character recognition part, the translation part, and the conversion part.

28. The combination apparatus as claimed in claim 27, wherein the outputable format is at least one of a digital image format to be outputable by printing or faxing, a voice signal to be recordable on a predetermined recording medium, and an image format to be displayable on an external display device.

29. The combination apparatus as claimed in claim 27, further comprising a host personal computer (PC) interface to receive the characters from a host PC, wherein the controller controls the translation part to translate the received characters into the different language.

30. A host personal computer (PC) driving a combination printing, scanning, copying, and faxing machine and comprising:
an I/O interface to receive images from a combination machine;
a combination machine driver to drive the combination machine and to convert the received images into a format to be output;
a memory part to record the converted; and
a host PC controller to control the I/O interface and the combination machine driver to convert the received images into the format to be output and to record converted images into the memory part.

31. The host PC as claimed in claim 30, wherein the outputable format is at least one of a digital image format to be outputable by printing or faxing, a voice signal to be recordable on a predetermined recording medium, and an image format to be displayable on an external display device.

32. The host PC as claimed in claim 30, wherein the memory part includes at least one of an image storage unit to store images and a predetermined recording medium to record a voice signal.

33. The host PC as claimed in claim 30, wherein the combination machine driver comprises:
a character recognition part to recognize characters on the images; and
at least one of a translation part to translate the recognized characters into a different language, a voice conversion part to convert the recognized characters into a voice signal, and an image conversion part to convert the translated characters into an image format displayable on an external display device.
